(19) United States
(12) Patent Application Publication
(10) Pub. No.: US 2024/0385096 A1
(43) Pub. Date: Nov. 21, 2024

(54) METHOD AND HEMATOLOGY ANALYZER FOR OPTICALLY ANALYZING BLOOD CELLS

(71) Applicant: Siemens Healthcare Diagnostics Inc., Tarrytown, NY (US)

(72) Inventors: Ramona Seliger, Wiesenttal-Muggendorf (DE); Martin Kraus, Fürth (DE); Peter Paulicka, Forchheim (DE); Tivadar Mach, Berlin (DE)

(21) Appl. No.: 18/696,343

(22) PCT Filed: Sep. 23, 2022
(86) PCT No.: PCT/US2022/076896

§ 371 Date: Mar. 27, 2024

(30) Foreign Application Priority Data
Sep. 28, 2021 (EP) 21199381.1

(51) Int. Cl. G01N 15/01; G01N 15/14; G01N 15/1409

(52) U.S. Cl. CPC G01N 15/01; G01N 15/1409; G01N 15/1484; G01N 2015/012; G01N 2015/016; G01N 2015/1486

(57) ABSTRACT

The disclosure relates to a method (100) of optically analyzing a blood cell from a blood sample with a device for optically analyzing a blood cell from a blood sample, the device (1) comprising a microfluidic chamber with at least one fluidic flow-through channel, a first inlet (6) port configured to introduce at least a part of the blood sample into the fluidic channel, a first outlet (7) port configured to discharge at least a part of the blood sample from the fluidic channel, a flow generating and stopping device configured to generate a flow of the sample through the channel and to stop the flow while a least a part of the sample comprising at least one blood cell is situated within the channel and wherein after stopping the flow the sample is only influenced by gravity and inertial forces such that blood cells within the sample sediment on a first area of a lower surface of the channel, wherein cells sedimented within the first area of the lower surface can be optically analyzed in the chamber.

### CROSS REFERENCE TO RELATED APPLICATIONS

This is a 371 of PCT/US2022/076896, filed Sep. 23, 2022, which claims priority to European Patent Application No. EP 21199381.1, filed Sep. 28, 2021, both of which are hereby incorporated by reference herein in their entireties for all purposes.

### FIELD OF THE DISCLOSURE

The disclosure relates to a device and method for optically analyzing a blood cell from a blood sample and relates to a device comprising a microfluidic chamber with at least one fluidic flow-through channel.

### BACKGROUND

Blood parameter analysis in central lab settings usually employs a combination of different chemical, electrical and optical measurement principles. Such approaches are space consuming, need a higher number of different reagents and maintenance activities. Further, in point of care testing, a number of different approaches exist which usually use optical measurement principles together with a computational analysis which may comprise use of artificial intelligence. For example, quantitative phase microscopy has emerged as a tool for biomedical research, due to its capability to make optical thickness variation of a specimen visible without the need of staining. Such microscopy techniques can for example be used for red blood cell (RBC) volume analysis on a cellular level and could allow simpler, less space consuming analysis settings without need of highly skilled staff for maintenance.

For an optical blood analysis, the different cell types present in the blood need to be arranged in a way that they can be imaged without overlapping each other, forming a monolayer of cells, in a sufficiently small time to allow high throughput of samples.

Moreover, a dilution in a suitable medium is needed to enable high-quality phase measurements, which is essential for reliable cellular RBC parameter measurement such as, e.g., mean corpuscula volume (MCV) and mean corpuscula hemoglobin concentration (MCHC). This relates to the so-called refractive index-thickness-coupling problem, see e.g., Gili Dardikman, Natan T. Shaked: Review on methods of solving the refractive index-thickness coupling problem in digital holographic microscopy of biological cells, Optics Communications, Volume 422, 2018, pages 8-16.

Further, to reach consistent results also for cell count and white blood cell (WBC) analysis, adequate numbers of all relevant cell types need to be present in the imaging area of an analysis chamber.

It would be advantageous to connect a measurement chamber to a fluidic system comprising, e.g., a pump while allowing a parallelization of the analysis workflow. A fluidic chamber which fits all these needs could support complete blood count measurements in a simpler set-up and would also be suitable for point of care testing settings.

Cell counting is usually performed with a Hemocytometer comprising, e.g., a Neubauer grid chamber and the blood sample is usually manually pipetted into this counting chamber. For point of care settings, there are several other approaches pursued. For example, artificially intelligence-based approaches employing viscoelastic focusing of blood cells and staining of the blood cells. Approaches based on computer-vision algorithms employing fluorescence staining of the blood cells. Or approaches based on contact optical microscopy employing labeling of the blood cells and absorption measurements. However, all those alternative approaches show only a relatively low correlation for MCV and MCHC when compared to standard complete blood count analysis results obtained, e.g., by an ADVIA 2120i Hematology System from Siemens Healthineers.

Further, there are several approaches pursued to solve the refractive index-thickness-coupling problem in context with RBC volume and hemoglobin concentration determination employing quantitative phase measurements. For example, approaches employ prior knowledge of the geometry of the investigated blood cells and include pre-preparation by sphering agents and use of geometric models. However, toxic chemicals are needed, and low performance of the geometrical models occur. Other approaches comprise separate height measurements, e.g., employing atomic force microscopy (AFM) and optical coherence tomography (OCT). Alternatively, at least two different surrounding media with different refraction indices (RI) are employed for measuring the same cell. However, due to prohibitively high efforts such approaches are not practicable in routine diagnostic laboratory settings. Alternatively, a highly dispersive surrounding medium is used employing at least two different measuring wavelengths for which a high RI difference of the surrounding medium exists. Further, phase and amplitude measurements are combined.

For the latter two approaches, it would be advantageous and there is a need to provide a faster, simple, and mass producible solution enabling phase calculations employing a one-shot optical device in a reusable fluidic chamber allowing sufficiently high throughput in diagnostic labs.

### SUMMARY OF THE INVENTION

The inventors found a device and a method for optically analyzing a blood cell from a blood sample employing a fluidic chamber allowing complete blood count measurements in a simple set-up which is also suitable for point of care testing. The mass producible solution enables also the possibility of phase calculations employing a one-shot optical device in the reusable fluidic chamber.

A first aspect of the present invention relates to a device for optically analyzing a blood cell from a blood sample, the device comprising:
a microfluidic chamber with at least one fluidic flow-through channel,
a first inlet port configured to introduce at least a part of the blood sample into the fluidic channel,
a first outlet port configured to discharge at least a part of the blood sample from the fluidic channel,
a flow generating and stopping device configured to generate a flow of the sample through the channel and to stop the flow while at least a part of the sample comprising at least one blood cell is situated within the channel and wherein after stopping the flow the sample is only influenced by gravity and inertial forces such that blood cells within the sample sediment on a first area of a lower surface of the channel,

wherein cells sedimented within the first area of the lower surface can be optically analyzed in the chamber,

wherein the channel has a height between 20 micrometers and 100 micrometers, preferably between 40 and 60 micrometers, most preferably 50 micrometers, and

wherein the first area of the lower surface has a size of at least 50 square mm, preferably at least 100 square mm.

In a second aspect, the present invention relates to a method of optically analyzing a blood cell from a blood sample with a device according to the first aspect of the present invention, the method comprising:

i) providing a blood sample obtained from a patient, wherein preferably the sample has been obtained from the patient prior to performing any step of the method,

ii) introducing at least a part of the blood sample into the channel via the first inlet port,

iii) generating a flow of the sample in the channel and stopping the sample flow with the flow generating and stopping device while at least a part of the sample comprising at least one blood cell is situated within the channel and wherein after stopping the flow the sample is only influenced by gravity and inertial forces such that blood cells within the sample sediment on a first area of a lower surface of the channel,

iv) waiting until at least one cell has been sedimented and is in contact with the lower surface of the channel within the first area, and

v) optically analyzing, in the chamber, cells sedimented within the first area of the lower surface.

The provided blood sample was obtained from the patient. That means that the blood sample was obtained from the patient prior to performing the method for analyzing the blood sample. Thus, the actual process of obtaining the blood sample from the patient is not part of the present method of optically analyzing a blood cell from the blood sample.

A third aspect of the present invention is directed to a hematology analyzer comprising a device according to the first aspect of the present invention and a control device which is configured to execute a method according to the second aspect of the present invention on the analyzer.

Further aspects and embodiments of the invention are disclosed in the dependent claims and can be taken from the following description, figures and examples, without being limited thereto.

### BRIEF DESCRIPTION OF THE DRAWINGS

The enclosed drawings should illustrate embodiments of the present invention and convey a further understanding thereof. In connection with the description, they serve as explanation of concepts and principles of the invention. Other embodiments and many of the stated advantages can be derived in relation to the drawings. The elements of the drawings are not necessarily to scale towards each other. Identical, functionally equivalent and acting equal features and components are denoted in the figures of the drawings with the same reference numbers, unless noted otherwise.

FIG. 1 shows schematically a device (1) for analyzing a blood sample according to the present invention.

FIG. 2 shows schematically a method (100) of optically analyzing a blood cell from a blood sample according to the present invention.

FIG. 3 shows schematically a hematology analyzer (200) according to the present invention.

### DETAILED DESCRIPTION OF THE INVENTION

### Definitions

Unless defined otherwise, technical and scientific terms used herein have the same meaning as commonly understood by one of ordinary skill in the art to which this invention belongs.

In the context of the present invention a blood sample is a sample which is provided from a patient and is particularly untreated. It is particularly a whole blood sample.

The patient within the scope of the present invention is not particularly restricted. According to certain embodiments, the patient in the present methods is a vertebrate, more preferably a mammal and most preferred a human patient.

A vertebrate within the present invention refers to animals having a vertebra, which includes mammals-including humans, birds, reptiles, amphibians and fish. The present invention thus is not only suitable for human medicine, but also for veterinary medicine.

Before the invention is described in exemplary detail, it is to be understood that this invention is not limited to the particular component parts of the process steps of the methods described herein as such methods may vary. It is also to be understood that the terminology used herein is for purposes of describing particular embodiments only and is not intended to be limiting. It must be noted that, as used in the specification and the appended claims, the singular forms “a,” “an” and “the” include singular and/or plural referents unless the context clearly dictates otherwise. For example, the term “a” as used herein can be understood as one single entity or in the meaning of “one or more” entities. It is also to be understood that plural forms include singular and/or plural referents unless the context clearly dictates otherwise. It is moreover to be understood that, in case parameter ranges are given which are delimited by numeric values, the ranges are deemed to include these limitation values.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

The use of ordinal number terminology (i.e., “first,” “second,” “third,” “fourth,” etc.) is solely for the purpose of differentiating between two or more items and, unless explicitly stated otherwise, is not meant to imply any sequence or order or importance to one item over another or any order of addition.

A first aspect of the present invention relates to a device for optically analyzing a blood cell from a blood sample, the device comprising:
a microfluidic chamber with at least one fluidic flow-through channel,
a first inlet port configured to introduce at least a part of the blood sample into the fluidic channel,
a first outlet port configured to discharge at least a part of the blood sample from the fluidic channel, and
a flow generating and stopping device configured to generate a flow of the sample through the channel and to stop the flow while a least a part of the sample comprising at least one blood cell is situated within the channel and wherein after stopping the flow the sample is only influenced by gravity and inertial forces such that blood cells within the sample sediment on a first area of a lower surface of the channel,

wherein cells sedimented within the first area of the lower surface can be optically analyzed in the chamber,

wherein the channel has a height between 20 micrometers and 100 micrometers, preferably between 40 and 60 micrometers, most preferably 50 micrometers, and

wherein the first area of the lower surface has a size of at least 50 square mm, preferably at least 100 square mm.

The device with the microfluidic chamber is the basis for a complete blood count with one single optical measuring principle. The device uses less reagents and is designed as a low maintenance set-up. Further, the device covers with its dimensions the needs of time efficiency and precision for a medical device.

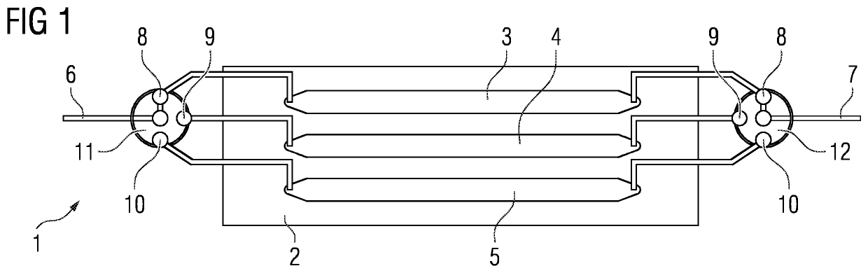

An exemplary device (1) for analyzing a blood sample according to the present invention is shown schematically in FIG. 1. The device (1) comprises a glass chip (2) which comprises a microfluidic chamber with a first, second and third fluidic flow-through channel (3, 4, 5). The first, second and third channels (3, 4, 5) are each connected to a first input valve (11) and a second output valve (12) which connect the channels with an inlet (6) and an outlet (7), respectively. The first and second valves are rotary valves which have a first, second and third position (8, 9, 10). Via the first position (8), the first channel (3) is fluidly connected to the inlet (6) and outlet (7), while the second and third position (9, 10) connect the second and third channel (4, 5) with the inlet (6) and outlet (7), respectively.

The height of the chamber is chosen in a way that blood cells from all traveling heights can reach the bottom of the chamber in a sufficiently short time when the fluid flow is stopped. The sedimentation time can be optimized moreover by adjustment of the fluid density and/or viscosity. For example, for phosphate-buffered saline, the sedimentation velocity ranges for single RBCs between 1-3 μm/s. Moreover, to keep light loss due to absorption in the fluid column above the object small, the height should advantageously be also as small as possible to enhance signal-to-noise ratios. On the other hand, to prevent the chamber from clogging, a minimal height is necessary, since the largest blood cells have diameters up to approximately 20 μm, like for example monocytes. Concerning both requirements, a chamber height of about 50 μm has been found to yield best conditions allowing optimized measurement results.

According to preferred embodiments, the channel has a width between 1 and 3 mm, preferably 2 mm, and/or the channel has a length between 20 mm and 100 mm, preferably between 40 mm and 60 mm, most preferably 50 mm. The dimensions of the chamber in length and/or width are chosen in a way, that a sufficient number of cells can be imaged after sedimentation without overlapping cells, such that the cells form a monolayer of cells. For a complete blood count with a five-part differential about 200-400 white blood cells usually need to be imaged to make sure to find also less present types of cells like, e.g., basophiles, which may be present in fewer copy numbers only. Taking into account the chosen chamber height and a certain dilution factor for the blood sample, e.g., a whole blood sample, one yields a necessary area of about 100 mm². So advantageously, a channel dimension of about 2 mm width and about 50 mm length can be chosen. The dilution rate is advantageously matched to the chamber volume in a way that the cells form a monolayer on the chamber bottom after all or almost all of them have sedimented. The necessary channel area can be reduced, e.g., by imaging the same region for the same patient with a fresh sedimented sample for several times and/or in several parallel chambers.

According to preferred embodiments, the microfluidic chamber comprises more than one fluidic flow-through channel, preferably three or more fluidic flow-through channels, wherein preferably the channels are arranged parallel to each other and are preferably homogeneous, i.e., they are of the same type and design and have the same spatial dimensions, or in other words, they are congeneric. This allows to increase the throughput of the device further for utilizing, e.g., the microfluidic chamber for a CBC, since more chambers are present on one chip in parallel. While one sample is imaged, the next sample is already allowed to sediment, allowing significantly increased throughput.

According to preferred embodiments, the inlet and/or outlet ports are connected to a fluidic system via one or more valves, preferably rotary valves. Advantageously, the fluidic system comprises a microfluidic system with pumps and is configurated to perform pre-constitution steps of the sample like, e. g., mixing.

According to preferred embodiments, an inner surface of the channel is modified such that attachment of cells of certain cell types is decreased or increased, for example, by employing chemical and/or mechanical means. Advantageously, the surface is modified by applying a cationic polyethylenimine and/or a steric hindrance polyethyleneglycol (PEG) coating to the surface. For example, monocytes show a very strong adhesion and spreading to a glass surface, what makes it more difficult to determine the cell condition state, i.e., for example, an abnormality. This can be reduced, e.g., by a cationic polyethylenimine and/or PEG coating on the glass surface.

According to preferred embodiments, the chamber comprises a bottom part forming a bottom wall of the channel, wherein the bottom wall has a thickness not greater than compensable with a coverglass correction in standard microscope objectives. Advantageously, the bottom of the chamber is sufficiently thin, e.g., about 170 μm or less, to be compensated with coverglass correction in standard microscope objectives.

According to preferred embodiments, the chamber consists partially or completely of a transparent material, preferable glass. This facilitates taking optical measurements of the sample, including imaging of blood cells.

The fluidic flow-through channel is not particularly restricted, as long as it comprises a structure having inner surfaces through which the blood sample can be flowed, wherein the structure is configured to contain the blood sample introduced. According to certain embodiments, the fluidic channel is a microchannel, particularly in a suitable sample vessel, made from a suitable material, e.g., glass and/or a suitable polymer resin, for analysis of the blood sample, e.g., with suitable transmissivity for a spectroscopic and/or microscopic analysis for analyzing the blood cell of the blood sample in the fluidic channel, optionally analyzing the settled cells at least for cell types, and/or analyzing at least lysed red blood cells. Alternatively, it can also be a pipe, etc., but preferably comprises at least two parallel inner and outer surfaces for settling cells and/or for ease of analysis. According to preferred embodiments, the fluidic channel is a microchannel in a suitable sample vessel, e.g., inside a chip made, e.g., from glass, plastic, etc.

Analyzing the settled cells is not particularly restricted and can be done using usual methods for cell analysis, e.g., microscopy and/or spectroscopy, e.g., for determining cell type, cell volume-particularly for red blood cells (RBC), and/or intracellular hemoglobin. For example, an analyzing unit can comprise a microscope and/or spectroscope, e.g., a UV-Vis spectroscope.

In a second aspect, the present invention relates to a method of optically analyzing a blood cell from a blood sample with a device according to the first aspect of the present invention, the method comprising:

i) providing a blood sample obtained from a patient, wherein preferably the sample has been obtained from the patient prior to performing any step of the method,

ii) introducing at least a part of the blood sample into the channel via the first inlet port,

iii) generating a flow of the sample in the channel and stopping the sample flow with the flow generating and stopping device while at least a part of the sample comprising at least one blood cell is situated within the channel and wherein after stopping the flow the sample is only influenced by gravity and inertial forces such that blood cells within the sample sediment on a first area of a lower surface of the channel,

iv) waiting until at least one cell has been sedimented and is in contact with the lower surface of the channel within the first area,

v) optically analyzing, in the chamber, cells sedimented within the first area of the lower surface.

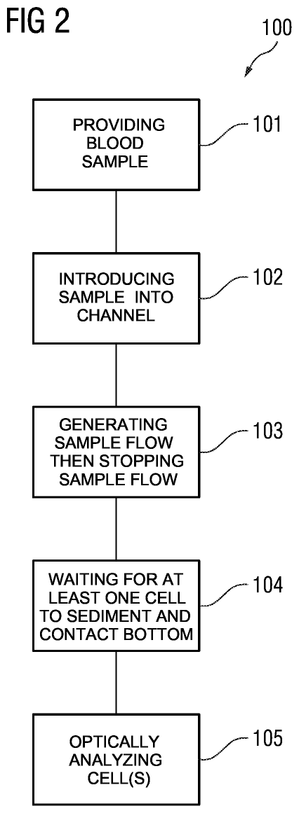

An exemplary method (100) for analyzing a blood sample according to the present invention is shown schematically in FIG. 2. The method (100) employs a device (1) as shown in FIG. 1. A first step comprises providing a blood sample obtained from a patient (101) for analysis. A second step comprises introducing at least a part of the blood sample into the channel via the first inlet port (102). A third step comprises generating a flow of the sample in the channel and stopping the sample flow with the flow generating and stopping device while at least a part of the sample comprising at least one blood cell is situated within the channel and wherein after stopping the flow the sample is only influenced by gravity and inertial forces such that blood cells within the sample sediment on a first area of a lower surface of the channel (103). A fourth step comprises waiting until at least one cell has been sedimented and is in contact with the lower surface of the channel within the first area (104). A fifth step comprises optically analyzing in the chamber cells sedimented within the first area of the lower surface (105).

According to preferred embodiments, at least one white blood cell (WBC), e.g., a monocyte, has been sedimented and is in contact with the lower surface of the channel within the first area in step iv).

According to certain embodiments, the blood sample is pumped into the channel, preferably with an optical read-out. The optical read-out allows introducing only a suitable amount of blood sample.

According to preferred embodiments, the blood sample comprises at least one red blood cell in a liquid medium and wherein optically analyzing cells in step v) comprises determining hemoglobin contents and/or volume of the red blood cell in the liquid medium using quantitative phase information and/or quantitative amplitude information obtained from the sample.

According to preferred embodiments, the liquid medium contains or exists of a dilution medium and preferably contains a dye type acid, e.g., Fast Green, preferably in a food-grade quality, e.g., Fast Green FCF. This enables a decrease of the error in phase measurements and possible subsequent hemoglobin concentration and/or volume calculations comprising determination of, e.g., mean corpuscula volume (MCV) and/or mean corpuscula hemoglobin concentration (MCHC). In particular in combination with one or more absorption measurements, a high-quality correlation to standard test methods can be achieved, i.e., a high correlation can be achieved when comparing analysis results obtained employing the approach of the present invention for MCV and MCHC to standard complete blood count analysis results, obtained, e.g., by an ADVIA 2120i Hematology System from Siemens Healthineers.

Fast Green FCF is a triarylmethane food dye. Its E number in the European Union and the European Free Trade Association is E143; it has a low toxicity and is not carcinogenic or genotoxic. An important property of such a dye is its water solubility, to yield a proper mixing with the blood sample, therefore a certain amount of polarity is necessary in the dye molecule. Another need is that the dye is not migrating into the blood cells, i.e., it does not permeate the lipoprotein cell membrane due to its molecular structure. Moreover, the dye has a dispersive refractive index in the visible or also in the UV or IR range, depending on the individual embodiment of the invention. Dispersion means that the refractive index changes with the wavelength of the light used for illumination.

In general, the so-called refractive index-thickness-coupling problem occurs when using quantitative phase for hemoglobin and volume determination of red blood cells (RBCs) in liquid samples. The phase equation for RBC in a liquid medium can be written as following with equation (i) and (ii):

$$Δ ϕ ( λ , x , y ) = \frac{2 π}{λ} [ β ( λ ) C ( x , y ) + Δ {n}_{w s} ( λ , x , y ) ] t ( x , y ) \qquad ( i )$$

$$with$$

$$Δ {n}_{w s} = {n}_{water} - {n}_{s u r r o u n d i n g} \qquad ( ii )$$

and where φ denotes the phase, λ the wavelength, β the refractive increment of hemoglobin, C the hemoglobin concentration, n_{water} the refractive index of water, n_{surrounding} the refractive index of the surrounding media, t the thickness and x, y the coordinates in the image, see e.g. also M. Mir, K. Tangella, and G. Popescu: Blood testing at the single cell level using quantitative phase and amplitude microscopy, Biomed. Opt. Express 2, pages 3259-3266 (2011).

Advantageously, a highly dispersive surrounding medium like, e.g., Fast green FCF is used which has a higher refractive index at or around 680 nm and a lower refractive index at or around, e.g., 460 nm. At these wavelengths, images are acquired for further post processing for quantitative phase calculation. In principle, even without the use of a surrounding media with a highly different refractive index compared to water, the refractive index-thickness-coupling problem can be solved for two wavelengths. However, in this case, due to the nearly vanishing second term in equation (i), i.e., (Δn_{ws}), one gets a rather unfavorable error propagation.

According to preferred embodiments, the liquid medium contains or exists in a dilution medium. Preferably, the liquid medium and/or the dilution medium has a higher refractive index at larger wavelengths, e.g., at or around 680 nm, and a lower refractive index at smaller wavelengths, e.g., at or around 460 nm. Preferably, images are acquired at a first wavelength, e.g., at or around 680 nm, where the index of refraction is higher, and at a second wavelength, e.g., at or around 460 nm, where the index of refraction is lower. Preferably, the images are further post processed for quantitative phase calculation. This has the advantage that the second term in equation (i), i.e., (Δn_{ws}), is larger and so one gets a more favorable error propagation allowing to solve the refractive index-thickness-coupling problem with higher accuracy. This enables possible subsequent hemoglobin concentration and/or volume calculations comprising determination of, e.g., mean corpuscula volume (MCV) and/or mean corpuscula hemoglobin concentration (MCHC) with higher accuracies.

Advantageously, an approach is chosen which combines both phase and amplitude calculations for a higher precision. For amplitude microscopy, Lambert Beer's Law is applicable. Therefore, in general only a bright-field image of the background and the cells is necessary. Advantageously, this can also be achieved in one single image when, e.g., the cell layer is adjusted in a way that sufficient large areas of background between the cells are present. Further, within certain approximations, it can be assumed that the absorption in RBCs is mainly or entirely caused by hemoglobin. Equation (iii) can thus be solved for one wavelength for the thickness of the specimen or hemoglobin concentration and used together with phase calculations at a different wavelength.

$${A}^{′} ( λ , x , y ) = - {log}_{10} ( \frac{I ( λ , x , y )}{{I}_{0} ( λ , x , y )} ) = \frac{ε ( λ ) t ( x , y ) C ( x , y )}{M} \qquad ( iii )$$

with A denoting absorption, λ the wavelength, I the intensity after passing the object, I₀ the intensity without the object, E the extinction coefficient of hemoglobin, t the thickness of the object, C the hemoglobin concentration and x, y the coordinates in the image, see e.g. also M. Mir, K. Tangella, and G. Popescu: Blood testing at the single cell level using quantitative phase and amplitude microscopy, Biomed. Opt. Express 2, pages 3259-3266 (2011).

Advantageously, a combination of data from measurements for more wavelengths and absorption and/or phase data is obtained, and the respective equations are numerically solved for least squares error.

With the device for optically analyzing a blood cell from a blood sample of the first aspect particularly, the method of optically analyzing a blood cell from a blood sample of the second aspect can be carried out. Thus, embodiments and implementations described with regard to the method of the second aspect above also may be applicable to the device of the first aspect, and vice versa.

In a third aspect, the present invention relates to a hematology analyzer comprising a device according to the first aspect of the present invention and a control device which is configured to execute a method according to the second aspect of the present invention on the analyzer.

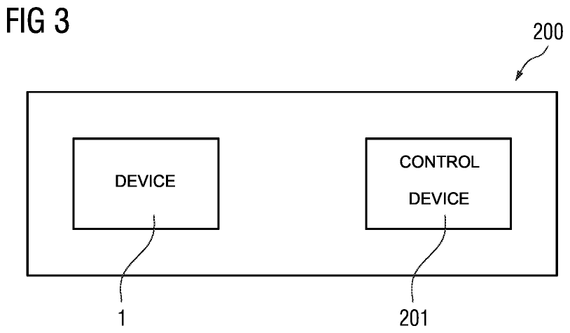

FIG. 3 shows schematically a hematology analyzer (200) according to the present invention.

An exemplary hematology analyzer (200) according to the present invention is shown schematically in FIG. 3. The hematology analyzer (200) comprises a device (1) shown in FIG. 1 and a control device (201) which is configured to execute a method (100) as shown in FIG. 2 on the analyzer (200).

### EXAMPLES

The present invention will now be described in detail with reference to several examples thereof. However, these examples are illustrative and do not limit the scope of the invention.

A blood sample from a patient was provided. Further, also a fluidic system including a glass chip comprising a microfluidic chamber with three parallel fluidic flow-through channels was provided, to which the sample was provided through an inlet via a first rotary valve in separate parts. The rotary valve has three positions. The first position connecting the inlet with the first channel, the second position connecting the inlet with the second channel, and the third position connecting the inlet with the third channel. Preferably, the sample is provided to the first, second and/or third channel one after the other by switching the position of the first rotary valve accordingly. The first, second and third channel has a height of 50 micrometers and a width of 2 mm and a length of 50 mm such that all three channels are homogeneous in size and design. An inner surface of each of the channels is modified such that attachment of cells of certain cell types is decreased or increased and is modified by applying a cationic PEG coating to the surface. The chamber comprises a bottom part forming a bottom wall of the channels, wherein the bottom wall has a thickness of 170 micrometers and consists partially or completely of a transparent material, preferable glass.

The blood was introduced subsequently into the first, second and third channel via the first inlet port. A flow was generated of the sample in the three channels, respectively, and the sample flow stopped with the flow generating and stopping device while at least a part of the sample comprising at least one blood cell was situated within the respective channel and wherein after stopping the flow the sample was only influenced by gravity and inertial forces such that blood cells within the sample sedimented on a first area of a lower surface of the respective channel. Subsequently, it was waited until at least one cell had sedimented and was in contact with the lower surface of the channel within the first area. Further, cells sedimented within the first area of the lower surface were optically analyzed. At least one WBC, e.g., at least one monocyte, had sedimented and was in contact with the lower surface of the channel within the first area and was optically analyzed. Optical analysis included imaging of the cells, in particular the sedimented WBC.

Additionally, or alternatively to other blood cells, the blood sample comprised red blood cells in a liquid medium. The sample was processed in analogy to as described above and the optical analysis included determining hemoglobin contents and/or volume of red blood cells in the liquid medium using quantitative phase information and quantitative amplitude information obtained from the sample.

With the present method and device, performing complete blood count measurements is possible in a simple set-up which is also suitable for point of care testing. Importantly, the microfluidic chamber is reusable. The mass producible solution enables also the possibility of phase calculations employing a one-shot optical device in the fluidic chamber.

### List of Reference Signs

1 device

2 glass chip

3 first channel

4 second channel

5 third channel

6 inlet

7 outlet

8 first position

9 second position

10 third position

11 first valve

12 second valve

100 method

101 providing a blood sample obtained from a patient

102 introducing at least a part of the blood sample into the channel via the first inlet port

103 generating a flow of the sample in the channel and stopping the sample flow with the flow generating and stopping device while at least a part of the sample comprising at least one blood cell is situated within the channel and wherein after stopping the flow the sample is only influenced by gravity and inertial forces such that blood cells within the sample sediment on a first area of a lower surface of the channel

104 waiting until at least one cell has been sedimented and is in contact with the lower surface of the channel within the first area

105 optically analyzing in the chamber cells sedimented within the first area of the lower surface

200 hematology analyzer

201 control device

1. A method of optically analyzing a blood cell from a blood sample with a device for optically analyzing a blood cell from a blood sample, the device comprising
a microfluidic chamber with at least one fluidic flow-through channel,
a first inlet port configured to introduce at least a part of the blood sample into the fluidic channel,
a first outlet port configured to discharge at least a part of the blood sample from the fluidic channel, and
a flow generating and stopping device configured to generate a flow of the sample through the channel and to stop the flow while a least a part of the sample comprising at least one blood cell is situated within the channel and wherein after stopping the flow the sample is only influenced by gravity and inertial forces such that blood cells within the sample sediment on a first area of a lower surface of the channel,
wherein cells sedimented within the first area of the lower surface can be optically analyzed in the chamber,
wherein the channel has a height between 20 micrometers and 100 micrometers, and
wherein the first area of the lower surface has a size of at least 50 square mm,
i) providing a blood sample obtained from a patient, wherein the sample has been obtained from the patient prior to performing any step of the method,
ii) introducing at least a part of the blood sample into the channel via the first inlet port,
iii) generating a flow of the sample in the channel and stopping the sample flow with the flow generating and stopping device while at least a part of the sample comprising at least one blood cell is situated within the channel and wherein after stopping the flow the sample is only influenced by gravity and inertial forces such that blood cells within the sample sediment on a first area of a lower surface of the channel,
iv) waiting until at least one cell has been sedimented and is in contact with the lower surface of the channel within the first area, and
v) optically analyzing, in the chamber, cells sedimented within the first area of the lower surface,
wherein the blood sample comprises at least one red blood cell in a liquid medium and wherein optically analyzing cells in step v) comprises determining hemoglobin contents or volume of the red blood cell in the liquid medium using quantitative phase information and quantitative amplitude information obtained from the sample.

2. The method according to claim 1, wherein the channel has a width between 1 and 3 mm.

3. The method according to claim 1, wherein the channel has length between 20 mm and 100 mm.

4. The method according to claim 1, wherein the microfluidic chamber comprises more than one fluidic flow-through channel, wherein the channels are arranged parallel to each other and are homogeneous.

5. The method according to claim 1, wherein the inlet or outlet ports are connected to a fluidic system via one or more valves.

6. The method according to claim 1, wherein an inner surface of the channel is modified such that attachment of cells of certain cell types is decreased or increased.

7. The method according to claim 6, wherein the inner surface is modified by chemical or mechanical means.

8. The method according to claim 7, wherein the inner surface is modified by applying a cationic polyethylenimine or polyethyleneglycol (PEG) coating to the inner surface.

9. The method according to claim 1, wherein the chamber comprises a bottom part forming a bottom wall of the channel, wherein the bottom wall has a thickness not greater than compensable with a coverglass correction in standard microscope objectives.

10. The method according to claim 1, wherein the chamber consists partially or completely of a transparent material.

11. The method according to claim 1, wherein at least one white blood cell has been sedimented and is in contact with the lower surface of the channel within the first area in step iv).

12. The method according to claim 1, wherein optically analyzing the cells in step v) comprises imaging the cells.

13. The method according to claim 12, wherein imaging the cells comprises acquiring images at a first wavelength at or around 680 nm, where the index of refraction is higher, and at a second wavelength at or around 460 nm, where the index of refraction is lower, wherein the images are further post processed for obtaining quantitative phase information.

14. The method according to claim 1, wherein the liquid medium contains or exists in a dilution medium and contains a dye type acid.

15. Hematology analyzer comprising a device for optically analyzing a blood cell from a blood sample according to claim 1 and a control device which is configured to execute a method according to claim 1 on the analyzer.

16. The hematology analyzer according to claim 15 wherein:
the channel has a height between 40 and 60 micrometers; and
the first area of the lower surface has a size of at least 100 square mm.

17. The hematology analyzer according to claim 15 wherein the liquid medium contains or exists in a dilution medium and contains a dispersive dye with regard to refractive index.

18. The hematology analyzer according to claim 15, wherein the channel has length between 40 mm and 60 mm.

19. The hematology analyzer according to claim 15, wherein the microfluidic chamber comprises three or more fluidic flow-through channels arranged parallel to each other.

20. The hematology analyzer according to claim 15, wherein the inlet or outlet ports are connected to a fluidic system via one or more rotary valves.
